(19) United States
(12) Patent Application Publication
(10) Pub. No.: US 2010/0284791 A1
(43) Pub. Date: Nov. 11, 2010

(54) APPARATUSES, SYSTEMS, AND METHODS FOR PREVENTING FOREIGN OBJECTS FROM BEING INGESTED INTO A JET ENGINE

(76) Inventor: Robert Jesse Flores, Madera, CA (US)

Correspondence Address: Robert Jesse Flores, 566 Kent Drive, Madera, CA, 93637, US

(21) Appl. No.: 12/463,597

(22) Filed: May 11, 2009

(51) Int. Cl. F04D 29/70; B23P 15/04

(52) U.S. Cl. 415/121.2; 29/889.2

(57) ABSTRACT

Apparatuses, systems, and methods for preventing foreign objects from being ingested into the air intake of a jet engine. Apparatuses can have a mount with an opening for fluid communication with an air intake of the engine, a generally pyramidal shaped tip, and at a generally frusto-pyramidal shaped shield between the tip and the mount. The tip and the shield can be generally conical, generally polygonal, generally elliptical, or generally lunal. A proximal end of the tip can overlap and attach to a distal end of the shield and a proximal end of the shield can overlap and attach to a distal end of the mount. The exposed lateral surface of the tip and/or the shield can be solid without openings therein. Systems can include a nacelle provided around a portion of the jet engine and a plurality of overlapping generally frusto-pyramidal guards attached to each other and the nacelle with a plurality of gussets. Methods can include attaching a generally frusto-conical mount to a portion of a nacelle surrounding the engine, attaching a proximal end of a generally frusto-conical shield to a distal end of the mount, and attaching a proximal end of a generally conical tip to a distal end of the shield.

### BACKGROUND OF THE INVENTION

1. Field of the Invention

The present invention is generally related to improving aeronautical safety. More particularly, embodiments of the present invention pertain to apparatuses, systems and methods for preventing foreign objects such as birds, ice, water, and earthen materials from being ingested into a jet engine.

2. Background and Description of Related Art

One of the most common threats to aviation safety results from damage to the aircraft which is caused by foreign objects, including but not limited to, rocks, sand, dirt, broken pavement, loose vehicle parts, tools, garbage, hail, ice, rain, and birds. Foreign object damage typically results when an object collides with a portion of the aircraft, such as the cockpit window, the fuselage, the wing, or is sucked into the air intake of an airplane engine. It is estimated that foreign object damage costs the aerospace industry over $10B annually in repair and incidental costs, and results in delays, flight changes, additional fuel costs, unexpected maintenance costs. In addition to the monetary harm caused by foreign object damage, in some instances, the damage can result in human injury and fatalities.

One particularly troublesome form of foreign object damage is that which results when an avian animal collides with a jet engine. Bird strikes generally occur during takeoff, landing, or during low altitude flight. According to a recent study, there were over 82,000 bird strikes between 1990 and 2007. There were over 7,200 bird strikes in 2007 alone, up from about 5,800 bird strikes in 2000. And experts expect the number of incidents to continue to soar over the next decade. As such, there is an urgent need for apparatuses, systems, and methods for reducing the avian threat to the airline industry.

There are at least three approaches to reducing the incident of, and damage caused by, bird strikes: flight path avoidance of bird flocks, bird population and habitat management, and modification to the aircraft design. In some conventional processes, a predictive Bird Avoidance Model, based on historical patterns of bird activity and strikes and live radar data, can provide a pilot with a bird activity “forecast” along the pilot's desired route. If the forecast is too high, the pilot can change their flight path to a path that has a lower activity forecast. Examples of such systems are the United States Military Aviation Hazard Safety System and the Royal Netherlands Bird Avoidance Model and Radar Observation of Bird Intensity systems. While there are numerous Bird Avoidance Models available for military applications, there is yet to be developed a similar civil aviation counterpart. In recent years, the United States Federal Aviation Administration has began placing radar units in commercial airports to assess the effectiveness of such systems.

The vast majority of incidents of bird strikes occur in areas surrounding airports. Thus, one way of reducing the incident of bird strikes is to create a zone around the airport where the bird population is appreciably reduced. Some conventional processes employ changing the habitat surrounding the airport to remove vegetation desirable to birds and to remove trees and other tall structures which the birds may use as perches. Other conventional processes include attempting to scatter the birds using frightening sounds, lights, canines, or predatory birds. Yet other conventional processes employ the use of lasers, firearms, or remote controlled airborne devices to scatter the birds. However, because birds can quickly adapt to their environment, the effectiveness of such processes are only temporary.

Another approach to minimize or all together eliminate foreign object damage to aircrafts is to include deflection devices on a portion of the aircraft. As illustrated in U.S. Pat. No. 4,165,849 to Fox, U.S. Pat. No. 6,883,751 to Koncsek, and U.S. Pat. No. 3,168,999 to Warren et al., some conventional deflection plates can be mounted to the fuselage of an aircraft. The plates can move to cover a portion of the air intake of the aircraft's engine to divert foreign objects from being ingested therein. However, these plates are deficient in that there is a significant amount of room between an extended deflection plate and the aircraft's engine through which foreign objects may pass. In addition, these deflection plates must be retracted after takeoff to prevent excessive drag caused by their large surface areas—thus they can not adequately deflect foreign matter when the aircraft reaches flight level.

Other conventional deflection shields may be permanently mounted in front of the engine. As illustrated in U.S. Pat. No. 6,871,819 to Garric, U.S. Pat. No. 6,138,950 Wainfan et al., U.S. Pat. No. 5,411,224 to Dearman et al., U.S. Pat. No. 4,149,689 to McDonald, U.S. Pat. No. 2,969,941 to Hobart, and U.S. Pat. No. 3,196,598 to Olson, some deflection plates can be placed in front of the air intake of the aircraft engine. Some of such deflection plates can include a fabric mesh, a perforated structure, a plurality of interconnected metallic rods, or combinations thereof. However, the openings of some of such plates may be too large, and thus not adequately deflect smaller debris particles. Yet other of such plates may have openings which are too small, thus clogging easily, which may potentially result in oxygen starvation of the engine.

In addition to apparatuses for deflecting debris, other devices may be mounted in front of an engine of an aircraft. As illustrated in U.S. Pat. No. 7,322,179 to Kobayashi et al., an air intake of a supersonic air-breathing engine can include a spike composed of a plurality of plates for forming aerodynamic compressive surfaces for guiding air inflow. Such a device, while it may be useful for guiding air inflow in supersonic aerospace vehicles, could not be used to deflect debris in commercial airplanes. This would be due in part because the apparatus of Kobayashi et al. precisely directs the entirety of the air inflow into a space between the cowl and a base. Thus, rather than be deflected away from the intake of the engine, the apparatus of Kobayashi et al. would direct any debris present in the air inflow directly towards the intake of the engine.

Therefore, there is a need for apparatuses, systems and methods that can adequately deflect debris such as birds, ice, water, and earthen materials from the air intake of a jet engine.

### SUMMARY OF THE INVENTION

Embodiments of the present invention provide apparatuses, systems and methods for preventing foreign objects such as birds, ice, water, and earthen materials from being ingested into a jet engine. In general, one or more overlapping shields can be placed in front of the intake of the jet engine which deflects foreign objects while at the same time providing air channel(s) in fluid communication with the intake of the engine.

In some embodiments of the present invention, an apparatus for preventing foreign objects from being ingested into a jet engine can include a mount for attachment to at least one portion of a nacelle surrounding the jet engine, a generally pyramidal shaped tip, and at least one generally frusto-pyramidal shaped shield between the tip and the mount. The mount can have an opening for fluid communication with an air intake of the engine and can have a proximal end with an outer diameter that is at least equal to a diameter of the air intake. A proximal end of the tip can overlap and attach to a distal end of the at least one shield and a proximal end of the at least one shield can overlap and attach to a distal end of the mount. The exposed lateral surface of at least one shield and/or the tip can be solid, without openings therein. In some embodiments, the tip and the at least one shield can be generally conical, generally polygonal, generally elliptical, or generally lunal.

In some embodiments, an apparatus for preventing foreign objects from being ingested into a get engine can include a mount for attachment to at least one portion of a nacelle surrounding the jet engine and a generally pyramidal shaped tip. The mount can have an opening for fluid communication with an air intake of the engine and can have a proximal end with an outer diameter that is at least equal to a diameter of the air intake. A proximal end of the tip can overlap and attach to a distal end of the mount.

In some embodiments, the mount can have a generally frusto-pyramidal distal portion and a flanged proximal portion that can overlap a frontal portion of the nacelle, such a fan cowl. In some other embodiments, a frontal portion of the nacelle can overlap the proximal end of the mount. At least one gusset can attach the mount to the at least one portion of the nacelle.

In some embodiments, the at least one shield can have an opening between a proximal end and a distal end for fluid communication with the opening of the mount. The proximal end can have an inner diameter that is at least equal to an outer diameter of the distal end of the mount. In some embodiments, the apparatus can have at least two generally frusto-pyramidal shaped shields, and a proximal end of a distal one of the shields can overlap a distal end of a proximal another of the shields. A plurality of gussets can attach an inner surface of the proximal end of the distal shield to an outer surface of the distal end of the proximal shield.

In some embodiments, the tip can be frusto-pyramidal and can have an opening between a distal end and the proximal end for fluid communication with the opening of the mount.

In some embodiments, the apparatus can include a heating element on the tip, the at least one shield, and/or the mount.

In some embodiments of the present invention, an apparatus for preventing foreign objects from being ingested into a jet engine can include a mount having an opening provided between a distal portion and a proximal portion thereof for fluid communication with an air intake of the engine, a generally frusto-conical tip having an opening provided between a distal end and a proximal end thereof for fluid communication with the opening of the mount, and at least one generally frusto-conical shield having an opening provided between a distal end and a proximal end thereof for fluid communication with the opening of the mount. A proximal end of the tip can overlaps the distal end of the at least one shield, the proximal end of the at least one shield can overlap the distal portion of the mount, and the proximal portion of the mount can overlap the front portion of the nacelle. Each of the tip, the at least one shield, and the mount can have a lateral surface without perforations therein. The mount can attach to the nacelle surrounding the engine and have a generally frusto-conical distal portion and a flanged proximal portion. A heating element can be provided on the tip, the at least one shield, and/or the mount. A plurality of gussets can attach an inside portion of the proximal end of the tip to an outside portion of the distal end of the at least one shield, an inside portion of the proximal end of the at least one shield to an outside portion of the distal portion of the mount, and/or an inside portion of the proximal portion of the mount to the front portion of the nacelle.

In some embodiments of the present invention, a system for preventing foreign objects from being ingested into a jet engine can include a nacelle provided around a portion of the jet engine which has a forward opening for fluid communication with an air intake of the jet engine, and a plurality of overlapping generally frusto-pyramidal guards attached to each other and the nacelle with a plurality of gussets. At least one of the guards can be attached to a portion of the nacelle and have an opening in fluid communication with the forward opening of the nacelle. In some embodiments, the plurality of guards can have lateral surfaces with exposed portions that are solid.

In some embodiments, the system can further include a de-icing element engaged with at least one of the plurality of shields. In some embodiments, the system can include a plurality of gussets for attaching the plurality of shields and the nacelle.

In some embodiments of the present invention, a method of preventing foreign objects from being ingested into a jet engine can include the steps of: attaching a generally frusto-conical mount having an opening for fluid communication with an air intake of the engine to a portion of a nacelle surrounding the engine; attaching a proximal end of at least one generally frusto-conical shield having an opening for fluid communication with the air intake of the engine to a distal end of the mount; and attaching a proximal end of a generally conical tip to a distal end of the at least one shield. In some embodiments, the method may further include the step of attaching a thermal energy source to the tip, the at least one shield, and/or the mount.

The present invention thus provides for the deflection of all foreign objects, including but not limited to hail, rain, snow, slush, ice sand, rocks, dirt, blown tire debris, and birds. In addition, the present invention provides increased flight performance, decreased vacuum noise and vibration, decreased fuel consumption, and equalization of air flow patterns and vortexes.

These and other objects, advantages, and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of an exemplary apparatus for preventing foreign objects from being ingested into a jet engine, in accordance with some embodiments of the present invention.

FIGS. 2-4 are partial cross-sectional views illustrating exemplary attachment devices, in accordance with some embodiments of the present invention.

FIGS. 5-10 are cross-sectional views illustrating exemplary mounts attached to a portion of a nacelle, in accordance with some embodiments of the present invention.

FIG. 11 is a perspective view of an exemplary gusset, in accordance with some embodiments of the present invention.

FIG. 12 is a cross-sectional view of the gusset of FIG. 11 along the 12-12 line, in accordance with some embodiments of the present invention.

FIG. 13 is a perspective view of another exemplary gusset, in accordance with some embodiments of the present invention.

FIG. 14 is a cross-sectional view of the gusset of FIG. 13 along the 14-14 line, in accordance with some embodiments of the present invention.

FIGS. 15-20 are side views illustrating exemplary apparatuses for preventing foreign objects from being ingested into a get engine, in accordance with some embodiments of the present invention.

FIGS. 21-26 are front views illustrating exemplary shapes of apparatuses for preventing foreign objects from being ingested into a jet engine, in accordance with some embodiments of the present invention.

### DETAILED DESCRIPTION OF THE PREFERRED EMBODIMENTS

The invention, in its various aspects, will be explained in greater detail below. While the invention will be described in conjunction with several exemplary embodiments, the exemplary embodiments themselves do not limit the scope of the invention. Similarly, the exemplary embodiments as illustrated in the accompanying drawings, wherein like or similar reference characters designate like or corresponding parts throughout the several views and examples, do not limit the scope of the exemplary embodiments and/or of the invention. Rather the invention, as defined by the claims, may cover alternatives, modifications, and/or equivalents of the exemplary embodiments. It is to be appreciated that although the invention is described in conjunction with turbojet and turbofan engines, some embodiments of the present invention also contemplate other turbine engines which extract energy from a fluid flow. It is also to be appreciated that although the invention is described in conjunction with aeronautical vehicles, some embodiments of the present invention also contemplate other vehicular and non-vehicular applications, for example and not limited to, aquatic vehicles and electric generators.

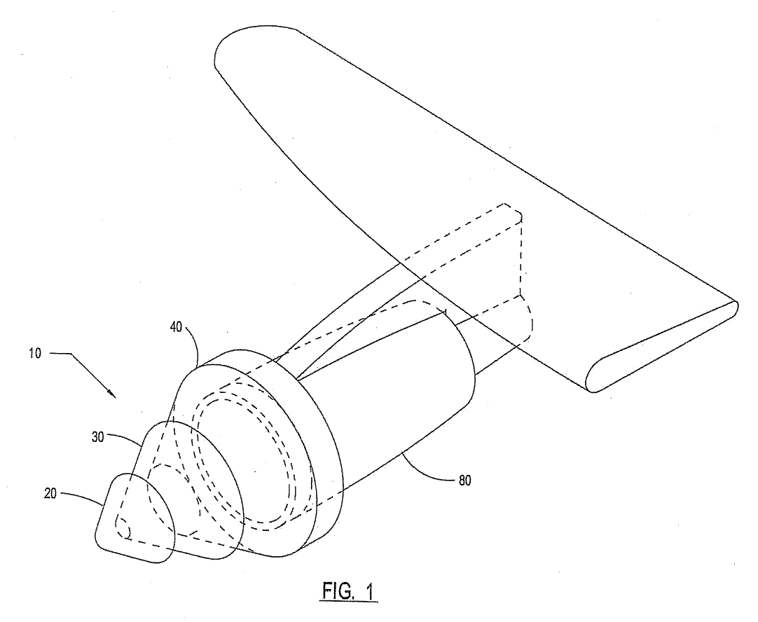

As shown in the exemplary illustration of FIG. 1, in some embodiments, nacelle 80 may be attached to the underside of a wing of an airplane. In some other embodiments, the nacelle may be provided in the wing itself, on or in the fuselage of the airplane itself, and/or may be engaged with both a portion of the wing and the fuselage. The nacelle may at least partially enclose a jet engine (not shown) which may have a forward portion comprising an air intake. In some examples, and without limitation, the front portion of the nacelle can include a fan cowl portion.

In some examples, and without limitation, the air intake of the jet engine can have a cross-sectional area that is equal to an inside cross-sectional area of the nacelle. In other examples, the air intake of the jet engine can have a cross-sectional area that is equal to an inside cross-sectional area of the fan cowl of the jet engine. In yet other examples, the air intake of the jet engine may have a cross-sectional area that is smaller than an inside cross-sectional of the nacelle and/or fan cowl. For example, and without limitation, the air intake may have a cross-sectional equal to about 95% of an inside cross-sectional area of the fan cowl. In other examples, the air intake may have a cross-sectional area equal to about 80% of an inside cross-sectional area of the nacelle.

Referring to the drawings generally, and specifically to the exemplary illustration of FIG. 1, in some embodiments, deflecting apparatus 10 can include mount 40 for attaching to a portion of nacelle 80, a generally pyramidal shaped tip 20, and at least one generally frusto-pyramidal shaped shield 30 between tip 20 and mount 40. It is to be appreciated that embodiments of the present invention contemplate deflecting apparatuses having any number of shields between the tip and the mount. However, for convenience and simplicity, the examples discussed herein and illustrated in the corresponding drawings concern apparatuses containing one shield 30 disposed between tip 20 and mount 40. In some examples, and without limitation, only one shield may be included. In other examples, two or more shields may be included.

In some embodiments, mount 40 can have a proximal end with an outer diameter that is at least equal to a diameter of the air intake of the engine. For example, as shown in the exemplary illustration of FIG. 1, and without limitation, mount 40 can have a generally frusto-pyramidal distal portion and a flanged proximal portion that can overlap a frontal portion of nacelle 80. In some examples, and without limitation, the flanged portion can overlap all or a portion of the fan cowl of nacelle 80. However, in some other embodiments, and as will be discussed in more detail below, the mount may have a proximal end that does not overlap a portion of the nacelle, but which still has a diameter that is at least equal to a diameter of the air intake of the engine. For example, and without limitation, a frontal portion of the nacelle can overlap the proximal end of the mount.

Similarly, in some embodiments, a proximal end of shield 30 can overlap a distal end of mount 40. For example, and without limitation, shield 30 can have a proximal end with an inner diameter that is greater than an outer diameter of a distal end of mount 40. In some embodiments, tip 20 can be frusto-pyramidal and can have a proximal end which may overlap a distal end of shield 30. As above, the present invention contemplates any number of shields. Thus, in some embodiments, the deflection apparatus can have at least two generally frusto-pyramidal shaped shields, and a proximal end of a distal one of the shields can overlap a distal end of a proximal another of the shields.

It is to be appreciated that in some embodiments of the present invention, a deflecting apparatus can include a mount and a tip, wherein a proximal end of the tip can overlap a distal end of mount 40. Thus in some examples, and without limitation, the tip can be attached directly to the mount without a shield there between. It is to be appreciated that those in the art can adapt the discussion herein to practice such deflecting apparatuses.

In some embodiments, mount 40 can have an opening for fluid communication with the air intake of the engine. For example, and without limitation, mount 40 can have an opening in a distal end in fluid communication with an opening in a proximal end. In other examples, mount 40 can have a plurality of openings in a distal end for fluid communication with the air intake of the engine. It is to be appreciated that the number and size of the openings in the mount may be determined with reference to, among other factors, the volumetric airflow requirements of a particular engine design.

Similarly, in some embodiments, shield 30 may have one or more openings between proximal and distal ends thereof in fluid communication with the opening of mount 40 and the air intake of the engine. For example, and without limitation, shield 30 may have one or more openings in a distal end for fluid communication through a proximal end to the opening(s) in the distal end of mount 40. In some further embodiments, a distal end of tip 20 may also include an opening for fluid communication with each opening(s) in the distal end of shield 30 and opening(s) in the distal end of mount 40.

In some examples, and without limitation, openings in tip 20, shield 30, and mount 40 may be circular. In other examples, the openings may be elliptical, polygonal, or any other shape. It is to be appreciated that, as shown, the openings may be located entirely on a distal end of the tip, one or more shields, and/or mount, or the openings may protrude slightly into lateral surfaces thereof. For example, and without limitation, the fluid opening in mount 40 may slightly extend onto the lateral surface of mount 40. However, such slight protrusion, if provided, should not extend down the lateral surface towards the proximal end of mount 40 past the point where the proximal edge of shield 30 overlaps mount 40. Thus in some embodiments, tip 20, one or more shields 30, and mount 40 may have non-overlapped lateral surfaces which are solid, without perforations therein. For example, and without limitation, the entire lateral surface of shield 30 may be solid, without any openings or perforations therein. In other examples, the overlapped portions may have openings while the non-overlapped portions are solid. Similarly, the entire lateral surface of mount 40 may be solid, without any openings therein, or the overlapped portions may have openings.

As above, the number and size of the openings in the mount may be determined with reference to, among other factors, the volumetric airflow requirements of a particular engine design. Furthermore, the number and size of the openings in the tip and/or one or more shields, if provided, may be determined with reference to the volumetric airflow requirements of the particular engine design. It is to be appreciated any number of openings can be provided on tip 20, one or more shields 30, and mount 40 in accordance with embodiments of the present invention. It is also to be appreciated that tip 20, shield 30, and mount 40 do not necessarily require the same number of openings. For example, and without limitation, tip 20 and shield 30 may each comprise a single opening on distal ends thereof, while mount 40 may comprise four openings. In some embodiments, the openings in each of the tip, the one or more shields, and the mount, if provided, may have different cross-sectional areas. For example, and without limitation, an opening provided on a distal end of tip 20 may be sufficiently smaller than that of an opening provided on a distal end of shield 30, which itself may be sufficiently smaller than that of the opening provided on the distal end of mount 40. In some embodiments, the total cross-sectional area of the openings may be about equal to the cross-sectional area of the engine's air intake. In some embodiments, the total cross-sectional area of the openings may be sufficiently less than the cross-sectional area of the engine's intake due to availability of air flow between the overlapping portions of the tip, one or more shields, and mount.

It is to be appreciated that when (i) the proximal end of tip 20 has an inside diameter greater than an outside diameter of the distal end of shield 30, (ii) the proximal end of shield 30 has an inside diameter greater than an outside diameter of the distal end of mount 40, and/or (iii) the proximal end of mount 40 has an inside diameter greater than an outside diameter of nacelle 80, annular spaces may be formed between tip 20, shield 30, mount 40, and/or nacelle 80 wherein air incident on deflecting apparatus 10 may pass though to the engine's air intake. For example, and without limitation, air may pass from the outside of apparatus 10 through an annular space between shield 30 and mount 40. In other examples, air may pass through an annular space between mount 40 and nacelle 80. In other examples, air may pass through annular spaces between each tip 20 and shield 30, shield 30 and mount 40, and mount 40 and nacelle 80. It is to be appreciated that in some embodiments, the ability of the apparatus to deflect foreign objects of a given size directly corresponds to the size of the annular space(s) provided between tip 20, shield 30, mount 40, and/or nacelle 80. Therefore, the respective dimensions of the tip, one or more shields, and mount should be selected to obtain adequate rejection of foreign objects.

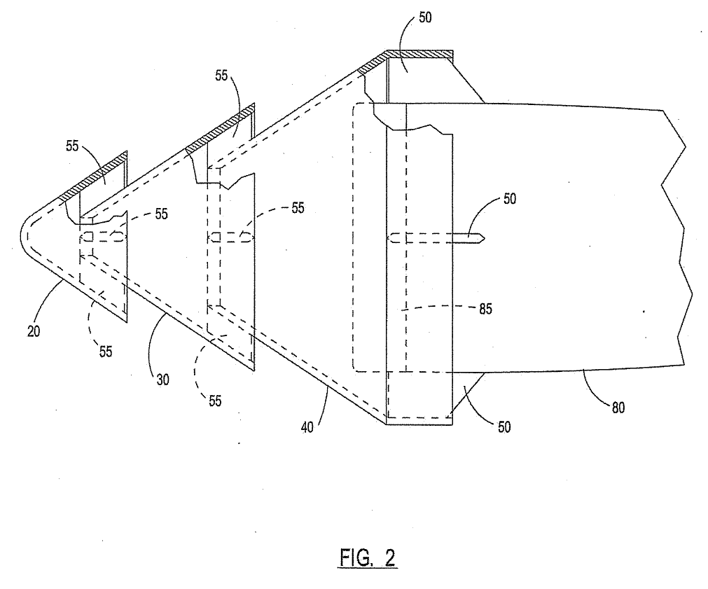

Referring now to the exemplary illustration of FIG. 2, a plurality of gussets may be provided for attaching tip 20, shield 30, mount 40, and nacelle 80. For example, and without limitation, a plurality of gussets 50 may attach mount 40 to an outside portion of nacelle 80 or fan cowl 85. In some examples, and without limitation, four gussets 50 may be provided. In other examples, nine gussets may be provided. It is to be appreciated however that the number of gussets 50 may be selected with reference to the expected forces exerted on the deflection apparatus and the nacelle.

In some embodiments, a plurality of gussets 55 may attach tip 20 to shield 30 and shield 30 to mount 40. It is to be appreciated that the number of gussets 55 for attaching tip 20 to shield 30 may be the same or different then the number of gussets 55 for attaching shield 30 to mount 40. For example, three gussets may attach tip 20 to shield 30 and five gussets may attach shield 30 to mount 40. In some embodiments, gussets 50 and 55 may be of the same general dimensions. In other embodiments, one or more of gussets 50 and 55 may be of different dimensions. For example, and without limitation, gussets 55 may have smaller dimensions then gussets 50.

In some examples, and without limitation, the gussets may be oriented perpendicular to a central axis of the nacelle. However, it is to be appreciated that the gussets may be skewed from the central axis of the nacelle. For example, and without limitation, the gussets may be oriented in a rotational pattern to form a vortex in the airflow entering through the annular channels between the tip, shields, mount, and nacelle. In some embodiments, the vortex may have the same rotation as the primary fan of the jet engine. In other embodiments, the vortex may have a different rotation as the primary fan of the jet engine. In other embodiments, gussets 55 may create a vortex having the same rotation as the primary fan and gussets 50 may create a vortex having a different rotation as the primary fan.

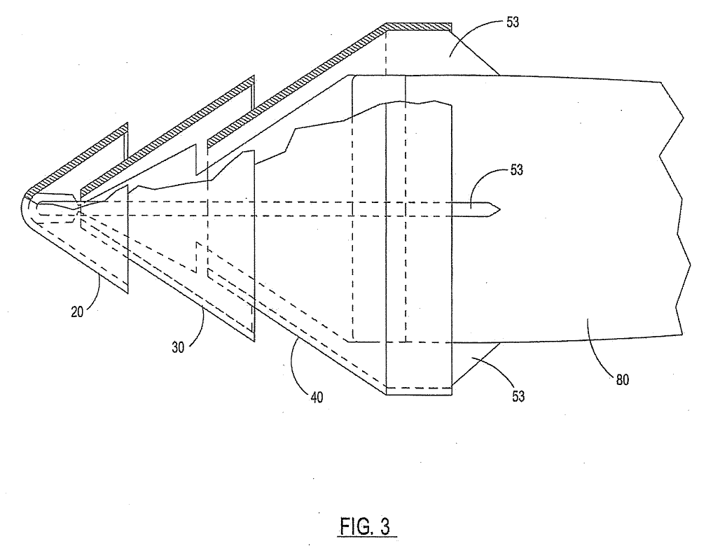

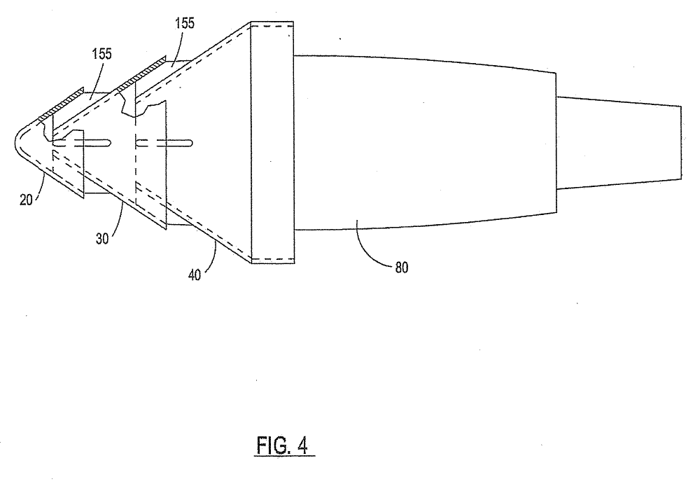

As shown in the exemplary illustration of FIG. 2, the gussets can be at least partially located between overlapping sections of the tip, the one or more shields, the mount, and the nacelle. In some embodiments, the gussets can be spot welded to one or more portions of the tip, the one or more shields, and the mount. For example, gussets 55 can be positioned and welded between a proximal end of tip 20 and a distal end of shield 30. In some embodiments, the gussets can be contained within overlapping portions of the tip, the shields, and/or the mount such that the gussets do not extend beyond peripheral edges thereof. For example, and without limitation, gussets 55 may be bounded by a proximal edge of tip 20 and a distal edge of shield 30. In other embodiments, the gussets may partially extend beyond the peripheral edges of the tip, the shields, and/or the mount. For example, and without limitation, gussets 50 may slightly protrude past a proximal edge of the flange of mount 40. It is to be appreciated that in some embodiments, the gussets for attaching the tip, the one or more shields, and/or the mount may extend beyond peripheral edges thereof while the gussets for attaching the mount to the nacelle may not extend beyond a peripheral edge of the mount. For example, referring now to FIG. 4, and without limitation, gussets 155 may slightly protrude past peripheral edges of tip 20 and shields 30 while the gussets (not shown) attaching the mount 40 to nacelle 80 may not.

In other embodiments, a plurality of gussets may attach each of the tip, the shields, the mount, and the nacelle. Referring now to the exemplary illustration of FIG. 3, and without limitation, gussets 53 may be attached to portions of each tip 20, shield 30, mount 40, and nacelle 80. In some embodiments, gussets 53 may be welded to an inside portion of tip 20, an inside portion of shield 30, an inside portion of mount 40, and an outside surface of nacelle 80 and/or the fan cowl. In some embodiments, gussets 53 may extend past a distal edge of shield 30, a distal edge of mount 40, and a proximal edge of mount 40 while not extending past a corresponding proximal edge of tip 20 or shield 30. However, it is to be appreciated that gussets 53 may or may not extend past proximal edges of tip 20, shield 30, and/or mount 40. In some examples, and without limitation, four gussets 53 may be provided and oriented perpendicular to a central axis of nacelle 80. In other examples, seven gussets 53 may be provided and have an orientation skewed from that of a central axis of nacelle 80. It is to be appreciated that any number of gussets may be provided at any orientation in accordance with some embodiments of the present invention.

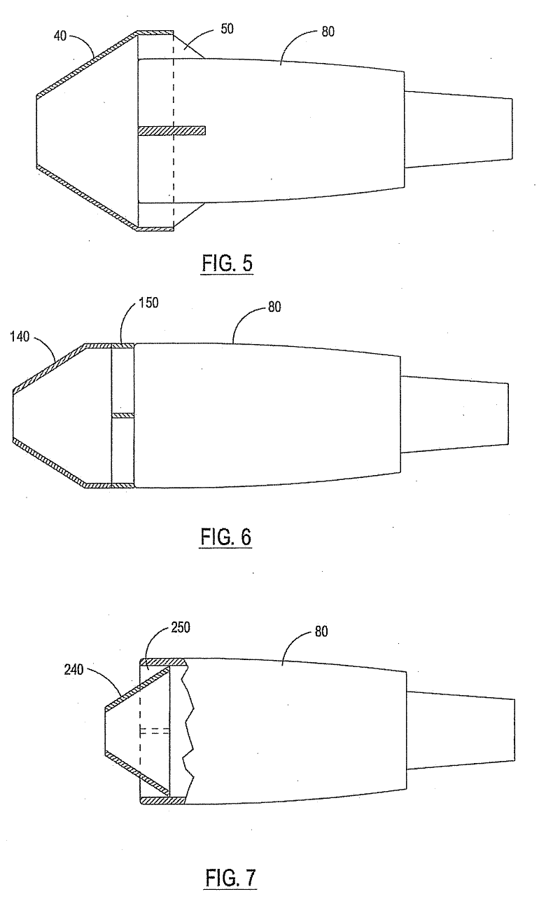

As above, in some embodiments the mount may be attached to at least a portion of the nacelle and have a proximal end with an outer diameter that is at least equal to a diameter of the intake of the jet engine. As shown in the exemplary illustration of FIG. 5, in some examples, and without limitation, mount 40 may have a flanged portion for overlapping a front portion of the nacelle 80 and/or fan cowl. A plurality of gussets 50 may be attached to both an inside surface of the flanged portion of the mount 40 and to an outside surface of the nacelle 80 and/or fan cowl.

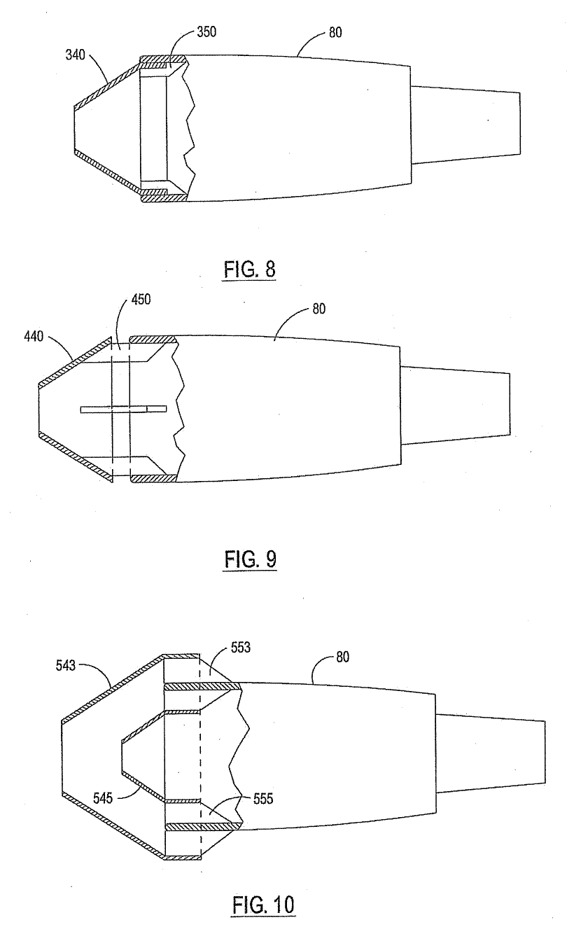

In other examples, as shown in the exemplary illustration of FIG. 6, and without limitation, mount 140 may have an outer diameter that is equal to a diameter of nacelle 80. A plurality of gussets 150 may be attached to a proximal edge of mount 140 and to a distal edge of nacelle 80 and/or fan cowl. In some examples, and without limitation, mount 140 can have a flanged proximal portion for attaching to nacelle 80. In other examples, and as shown in the exemplary illustration of FIG. 8, mount 440 may not have a flanged proximal portion. A plurality of gussets 450 may be attached to an inside portion of a proximal end of mount 440 and an inside portion of a distal end of nacelle 80.

In some embodiments, the mount may have an outer diameter that is (i) at least equal to a diameter of the air intake of the engine but (ii) less than or equal to an inside diameter of the nacelle. For example, and without limitation, the air intake of the jet engine may have a smaller cross-sectional area than the inside of the nacelle. In some examples, as shown in the exemplary illustration of FIG. 8, and without limitation, mount 340 may have a flanged proximal portion having an outside diameter that is about equal to an inside diameter of nacelle 80. A plurality of gussets 350 may be attached both to an inside portion of mount 340 and to an inside portion of nacelle 80 and/or fan cowl. In other examples, as shown in the exemplary illustration of FIG. 7, and without limitation, mount 240 may not have a flanged proximal portion. A plurality of gussets may be attached to an outside portion of mount 240 and an inside portion of nacelle 80 and/or fan cowl.

In some embodiments, the mount may include at least two sections. Referring to the exemplary illustration of FIG. 10, and without limitation, a first section 543 may have a proximal end having a diameter greater than a diameter of nacelle 80 and attached thereto by gussets 553. A second section 545 may have a proximal end having a diameter less than a diameter of nacelle 80 and attached thereto by gussets 555. In some examples, and without limitation, gussets 553 may be separate from gussets 555. In other examples, first section 543 and second section 545 may be attached to each other and to nacelle 80 by a plurality of gussets, each gusset being attached to an inside portion of section 543, an outside portion of section 545, an outside portion of nacelle 80, and an inside portion of nacelle 80. In some examples, and without limitation, the gusset can have a slot for receiving a front edge of nacelle 80 and/or fan cowl. In some examples, and without limitation, each gusset can be welded to corresponding portions of first section 543 and second section 545. The mount may then be placed over the front edge of nacelle 80 and each gusset can be welded or otherwise attached to nacelle 80. In some examples, and without limitation, the gusset can be attached to the nacelle by set screws, bolts, or similar fasteners.

It is to be appreciated that the above discussion is meant to be illustrative of numerous exemplary ways in which the mount may be engaged with the nacelle in accordance with some embodiments of the present invention. Thus, the present invention is not limited to the exemplary configurations disclosed above, but rather includes any configuration of mounts and gussets where the mount has a proximal end with an outer diameter that is greater than a diameter of the air intake of the jet engine.

Referring now to FIGS. 11-14, it is to be appreciated that gussets in accordance with embodiments of the present invention can have different shapes. As shown in the exemplary illustration of FIGS. 11 and 12, and without limitation, gusset 650 can have a rectangular shape. In other examples, and as shown in the exemplary illustration of FIGS. 13-14, gusset 750 can have a trapezoidal shape. However, it is to be appreciated that the gussets can have any aerodynamic shape. For example, and without limitation, one or more of the gussets can have a teardrop shape.

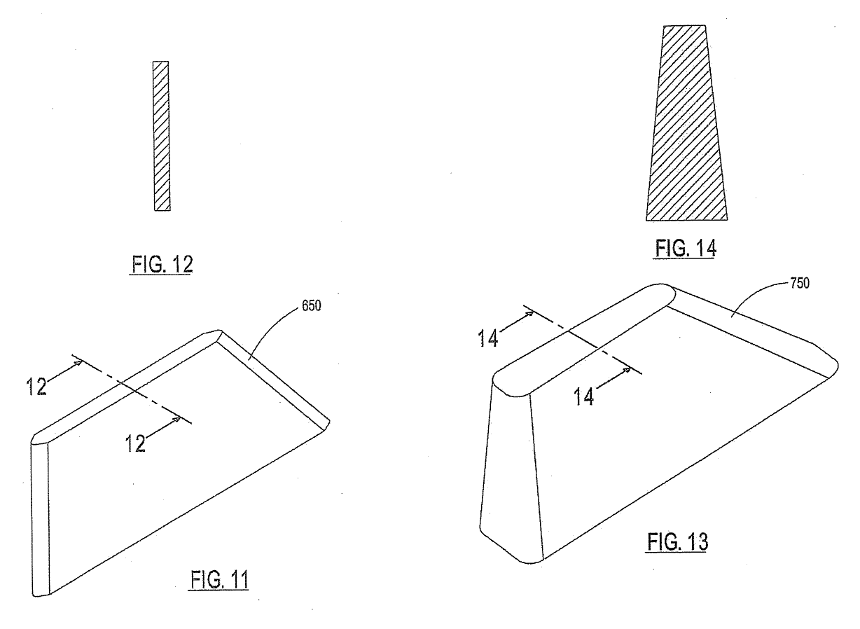

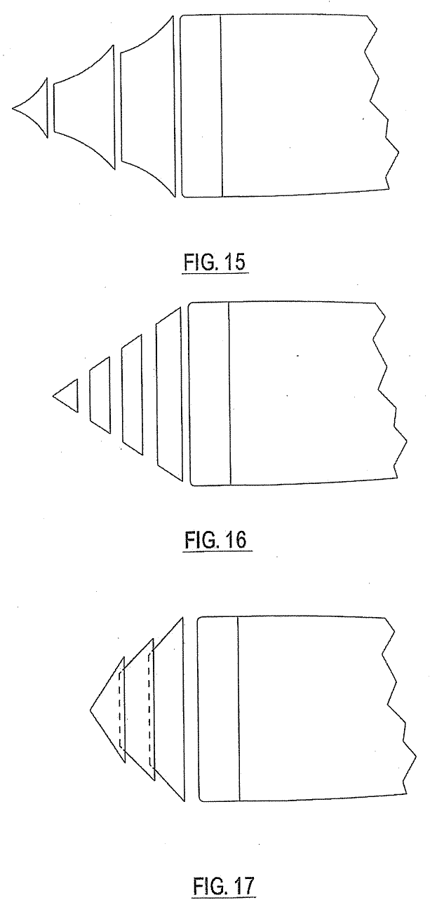

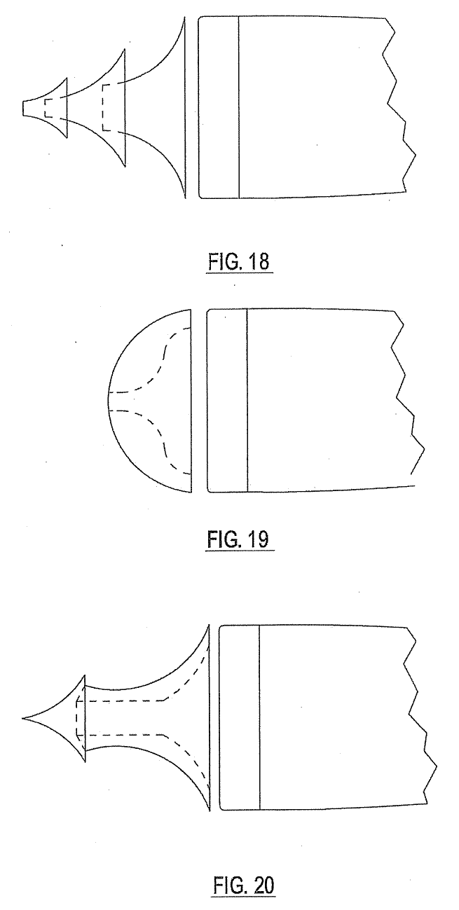

Referring now to the exemplary illustrations of FIGS. 15-26, and without limitation, the present invention contemplates many different shapes and configurations of the tip, the shields, and the mount. For example, as illustrated in the side profile views of FIGS. 15-20, and without limitation, the lateral surfaces of the tip, shields, and/or mount may be flat, arched, or rounded. However, it is to be appreciated that the exposed lateral surfaces of the tip, shields, and mount may have any aerodynamic shape in accordance with some embodiments of the present invention. In some examples, the tip, shields, and mounts may have the same general shape. In other examples, one or more of the tip, shields, and mounts may have different shapes.

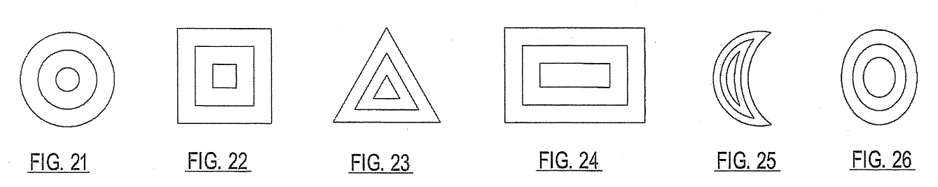

As above, in some embodiments, the tip may be generally pyramidal and the at least one shield may be frusto-pyramidal. In some further embodiments, the tip and the at least one shield can be generally conical, generally polygonal, generally elliptical, or generally lunal. For example, as illustrated in the frontal views of FIGS. 21-26, and without limitation, the base of the pyramidal shaped tip, the frusto-pyramidal shaped shields, and the mount may be circular, square, triangular, rectangular, lunar, or ovular. However, it is to be appreciated that other shapes are contemplated in accordance with embodiments of the present invention. It is also to be appreciated that the shape of the tip, shields, and mount may be determined with reference to the shape of the nacelle and/or engine air intake.

In some embodiments, the deflecting apparatus can further include a heating or de-icing element on the tip, the shields, and/or the mount. For example, and without limitation, resistive heating elements may be attached to or embedded in a portion of the tip. In other examples, a tube or a pipe may be included for providing a portion of the engine exhaust on a surface of the mount.

Referring back to FIG. 1, in some embodiments, a system for preventing foreign objects from being ingested into a jet engine can include nacelle 80 and a plurality of generally pyramidal overlapping guards 20, 30, 40 attached to each other and nacelle 80 with a plurality of gussets (not shown). In some embodiments, at least one of guards 30, 40 have an opening in fluid communication with a forward opening of nacelle 80. In some embodiments, each of guards 20, 30, 40 may have a solid lateral surface. In some embodiments, the non-overlapped portions of guards 20, 30, 40 may be solid while the overlapped portions may have openings or perforations therein. In some embodiments, a de-icing element may be engaged with at least one of shields 20, 30, 40.

Thus, the present invention provides efficient and economical apparatuses, systems, and methods for preventing foreign objects from being ingested into a jet engine. It is to be understood that variations, permutations, and modifications of the present invention may be made without departing from the scope thereof. As such, one or more features of some exemplary embodiments as described above may be practiced in conjunction with some other exemplary embodiments. For example, and without limitation, gusset 350 of FIG. 8 may be replaced with a continuous-type gusset similar to gusset 53 of FIG. 3. In other examples, tip 20, shields 30, and mount 40 of FIG. 1 may have geometrical configurations similar to the exemplary apparatus as illustrated in FIG. 18. It is also to be understood that the present invention is not to be limited by the specific embodiments disclosed herein or as illustrated in the referenced drawings, but rather, is defined in accordance with the appended claims when read in light of the foregoing specification.

What is claimed is:

1. An apparatus for preventing foreign objects from being ingested into a jet engine, comprising:
a) a mount for attachment to at least one portion of a nacelle surrounding said jet engine, wherein said mount comprises an opening for fluid communication with an air intake of said engine and said mount has a proximal end with an outer diameter that is at least equal to a diameter of said air intake;
b) a generally pyramidal shaped tip; and
c) at least one generally frusto-pyramidal shaped shield between said tip and said mount, wherein a proximal end of said tip overlaps and is attached to a distal end of said at least one shield, and wherein a proximal end of said at least one shield overlaps and is attached to a distal end of said mount.

2. The apparatus of claim 1, wherein each of said tip and said at least one shield are one of the group consisting of generally conical, generally polygonal, generally elliptical, and generally lunal.

3. The apparatus of claim 1, wherein said mount comprises a generally frusto-pyramidal distal portion and a flanged proximal portion.

4. The apparatus of claim 3, wherein said proximal end of said mount overlaps a frontal portion of said nacelle.

5. The apparatus of claim 4, wherein said proximal end of said mount overlaps a portion of a fan cowl of said nacelle.

6. The apparatus of claim 1, wherein a frontal portion of said nacelle overlaps said proximal end of said mount.

7. The apparatus of claim 1, further comprising at least one gusset for attaching said mount to said at least one portion of said nacelle.

8. The apparatus of claim 1, wherein said proximal end of said at least one shield has an inner diameter that is at least equal to an outer diameter of said distal end of said mount.

9. The apparatus of claim 1, wherein said at least one shield has an opening between said proximal end and said distal end, said opening for fluid communication with said opening of said mount.

10. The apparatus of claim 1, wherein the exposed lateral surface of said at least one shield is solid.

11. The apparatus of claim 1, comprising at least two generally frusto-pyramidal shaped shields, wherein a proximal end of a distal one of said shields overlaps a distal end of a proximal another of said shields.

12. The apparatus of claim 11, further comprising a plurality of gussets for attaching an inner surface of said proximal end of said distal shield to an outer surface of said distal end of said proximal shield.

13. The apparatus of claim 1, wherein the entirety of said tip has a solid lateral surface.

14. The apparatus of claim 1, wherein said tip is frusto-pyramidal and has an opening between a distal end and said proximal end, said opening for fluid communication with said opening of said mount.

15. The apparatus of claim 1, further comprising a heating element on one of the group consisting of said tip, said at least one shield, said mount, and combinations thereof.

16. An apparatus for preventing foreign objects from being ingested into a jet engine, comprising:
a) a mount for attachment to at least one portion of a nacelle surrounding said jet engine, wherein said mount comprises an opening for fluid communication with an air intake of said engine and said mount has a proximal end with an outer diameter that is at least equal to a diameter of said air intake; and
b) a generally pyramidal shaped tip, wherein a proximal end of said tip overlaps and is attached to a distal end of said mount.

17. An apparatus for preventing foreign objects from being ingested into a jet engine, comprising:
a) a mount for attachment to an outside surface of a front portion of a nacelle surrounding said jet engine, said mount comprising a generally frusto-conical distal portion and a flanged proximal portion, and having an opening provided between said distal portion and said proximal portion for fluid communication with an air intake of said engine;
b) a generally frusto-conical tip having an opening provided between a distal end and a proximal end thereof for fluid communication with said opening of said mount;
c) at least one generally frusto-conical shield between said tip and said mount, wherein said at least one shield has an opening provided between a distal end and a proximal end thereof for fluid communication with said opening of said mount;
d) a heating element on one of the group consisting of said tip, said at least one shield, said mount, and combinations thereof; and
e) a plurality of gussets for attaching one of the group consisting of: an inside portion of said proximal end of said tip to an outside portion of said distal end of said at least one shield, an inside portion of said proximal end of said at least one shield to an outside portion of said distal portion of said mount, an inside portion of said proximal portion of said mount to said front portion of said nacelle, and combinations thereof,
f) wherein said proximal end of said tip overlaps said distal end of said at least one shield, said proximal end of said at least one shield overlaps said distal portion of said mount, and said proximal portion of said mount overlaps said front portion of said nacelle, and wherein each of said tip, said at least one shield, and said mount comprise exposed lateral surfaces without perforations therein.

18. A system for preventing foreign objects from being ingested into a jet engine, comprising:
a) a nacelle provided around a portion of said jet engine, said nacelle having an forward opening for fluid communication with an air intake of said jet engine; and
b) a plurality of overlapping generally frusto-pyramidal guards attached to each other and said nacelle with a plurality of gussets, wherein at least one of said guards has an opening in fluid communication with said forward opening of said nacelle and is attached to a portion of said nacelle.

19. The system of claim 18, further comprising a de-icing element engaged with at least one of said plurality of guards.

20. The system of claim 18, wherein an exposed lateral surface of each of said plurality of guards is solid.

21. The system of claim 18, further comprising a plurality of gussets for attaching said plurality of guards and said nacelle.

22. A method of preventing foreign objects from being ingested into a jet engine, comprising the steps of:
a) attaching a generally frusto-conical mount having an opening for fluid communication with an air intake of said engine to a portion of a nacelle surrounding said engine;
b) attaching a proximal end of at least one generally frusto-conical shield having an opening for fluid communication with said air intake of said engine to a distal end of said mount; and
c) attaching a proximal end of a generally conical tip to a distal end of said at least one shield.

23. The method of claim 22, further comprising the step of attaching a thermal energy source to one of the group consisting of said tip, said at least one shield, said mount, and combinations thereof.
